(19) United States
(12) Patent Application Publication
(10) Pub. No.: US 2024/0359106 A1
(43) Pub. Date: Oct. 31, 2024

(54) VIRTUAL ITEM PROCESSING METHOD AND APPARATUS, ELECTRONIC DEVICE, STORAGE MEDIUM, AND PROGRAM PRODUCT

(71) Applicant: Tencent Technology (Shenzhen) Company Limited, Shenzhen (CN)

(72) Inventors: Dan SUN, Shenzhen (CN); Huanran LIU, Shenzhen (CN)

(21) Appl. No.: 18/766,458

(22) Filed: Jul. 8, 2024

Related U.S. Application Data
(63) Continuation of application No. PCT/CN2023/102688, filed on Jun. 27, 2023.

(30) Foreign Application Priority Data
Aug. 12, 2022 (CN) 202210971198.2

(51) Int. Cl. A63F 13/69; A63F 13/525

(52) U.S. Cl. CPC A63F 13/69; A63F 13/525

(57) ABSTRACT

This application provides a virtual item processing method performed by an electronic device. The method includes: displaying a processing entrance for a virtual item in a virtual scene; displaying a first processing interface in response to a trigger operation for the processing entrance, the first processing interface including at least a processing control; in response to a trigger operation for the processing control, updating the virtual item; and in response to an interface jump trigger operation, switching from the first processing interface to a second processing interface different from the first processing interface.

### CROSS-REFERENCE TO RELATED APPLICATIONS

This application is a continuation application of PCT Patent Application No. PCT/CN2023/102688, entitled “VIRTUAL ITEM PROCESSING METHOD AND APPARATUS, ELECTRONIC DEVICE, STORAGE MEDIUM, AND PROGRAM PRODUCT” filed on Jun. 27, 2023, which is based upon and claims priority to Chinese Patent Application No. 202210971198.2, entitled “VIRTUAL ITEM PROCESSING METHOD AND APPARATUS, ELECTRONIC DEVICE, STORAGE MEDIUM, AND PROGRAM PRODUCT” filed on Aug. 12, 2022, both of which are incorporated herein by reference in their entirety.

### FIELD OF THE TECHNOLOGY

The present application relates to the field of human-machine interaction technologies for computers, and in particular, to a virtual item processing method and apparatus, an electronic device, a storage medium, and a program product.

### BACKGROUND OF THE DISCLOSURE

Technologies for human-computer interaction in a virtual scene based on graphics processing hardware can realize diversified interaction between virtual objects controlled by users or artificial intelligence according to the actual application requirements, and have extensive practical value. For example, a real battle process between virtual objects can be simulated in a virtual scene such as a game.

Using shooting games as an example, in most shooting games, there is a firearm processing system. Using the processing system as an example, because the firearm has a plurality of components that can be processed, when processing a plurality of components of a gun, a player needs to repeatedly perform the following processing: selecting a component (such as a muzzle) that needs to be processed in a whole gun interface, and entering a muzzle processing interface; after completing the processing of the muzzle in the muzzle processing interface, returning to the whole gun interface; select another component (such as a handguard) that needs to be processed, and entering a handguard processing interface; and after completing the processing of the handguard in the handguard processing interface, returning to the whole gun interface, and select still another component that needs to be processed.

It can be seen that, in the related technologies, when processing the firearm, the player needs to frequently jump between the whole gun interface and processing interfaces of corresponding components, resulting in low processing efficiency of the virtual item.

### SUMMARY

Embodiments of this application provide a virtual item processing method and apparatus, an electronic device, a computer-readable storage medium, and a computer program product, and can improve virtual item processing efficiency.

Technical solutions of the embodiments of this application are implemented as follows:

An embodiment of this application provides a virtual item processing method, executed by an electronic device, and including:
displaying a processing entrance for a virtual item in a virtual scene;
displaying a first processing interface in response to a trigger operation for the processing entrance, the first processing interface comprising at least a processing control;
in response to a trigger operation for the processing control, updating the virtual item; and
in response to an interface jump trigger operation, switching from the first processing interface to a second processing interface different from the first processing interface.

An embodiment of this application provides an electronic device, including:
a memory, configured to store executable instructions; and
a processor, configured to: when executing the executable instructions stored in the memory, cause the electronic device to implement the virtual item processing method according to the embodiments of this application.

An embodiment of this application provides a non-transitory computer-readable storage medium, having computer-executable instructions stored therein, the computer-executable instructions, when executed by a processor of an electronic device, causing the electronic device to perform the virtual item processing method according to the embodiments of this application.

An embodiment of this application provides a computer program product, having a computer program or computer-executable instructions stored therein, the computer program or the computer-executable instructions, when executed by a processor, being configured for realizing the virtual item processing method according to the embodiments of this application.

The embodiments of this application have the following beneficial effects:

When an interface jump trigger operation is received in a first processing interface corresponding to a first component, the first processing interface can jump to a second processing interface corresponding to a second component. In comparison with returning to an upper level first to select the second component and entering the corresponding processing interface, the processing of a component can be carried out quickly after the processing of another component is completed. This saves operation time and improves virtual item processing efficiency.

### BRIEF DESCRIPTION OF THE DRAWINGS

FIG. 1A is a schematic diagram of an application mode of a virtual item processing method according to an embodiment of this application.

FIG. 1B is a schematic diagram of an application mode of a virtual item processing method according to an embodiment of this application.

FIG. 2 is a schematic structural diagram of an electronic device according to an embodiment of this application.

FIG. 3 is a schematic flowchart of a virtual item processing method according to an embodiment of this application.

FIG. 4A to FIG. 4C are schematic diagrams of application scenarios of a virtual item processing method according to an embodiment of this application.

FIG. 5 is a schematic structural diagram of a virtual rifle according to an embodiment of this application.

FIG. 6 is a schematic flowchart of a virtual item processing method according to an embodiment of this application.

FIG. 7A and FIG. 7B are schematic diagrams of application scenarios of a virtual item processing method according to an embodiment of this application.

FIG. 8 is a schematic flowchart of a virtual item processing method according to an embodiment of this application.

FIG. 9 is a schematic diagram of quadrants according to an embodiment of this application.

### DESCRIPTION OF EMBODIMENTS

To make the objectives, technical solutions, and advantages of this application clearer, the following describes this application in further detail with reference to the accompanying drawings. The described embodiments are not to be considered as a limitation to this application. All other embodiments obtained by a person of ordinary skill in the art without creative efforts shall fall within the protection scope of this application.

In the following descriptions, “some embodiments” involved therein describes a subset of all possible embodiments, but the “some embodiments” may be the same subset or different subsets of all possible embodiments, and may be combined with each other without conflict.

In the embodiments of this application, relevant data such as user information (for example, data related to virtual items owned by a virtual object controlled by a user) is involved. When the embodiments of this application are applied to specific products or technologies, permission or consent of a user needs to be obtained, and collection, use, and processing of the relevant data need to comply with relevant laws, regulations, and standards of relevant countries and regions.

In the following descriptions, the involved term “first/second/ . . . ” is merely intended to distinguish between similar objects but does not necessarily indicate a specific order of an object. “First/second/ . . . ” is interchangeable in terms of a specific order or sequence if permitted, so that the embodiments of this application described herein can be implemented in a sequence in addition to the sequence shown or described herein.

Unless otherwise defined, meanings of all technical and scientific terms used in this specification are the same as those usually understood by a person skilled in the art to which this application belongs. Terms used in this specification are merely intended to describe objectives of the embodiments of this application, but are not intended to limit this application.

Before the embodiments of this application are further described in detail, terms involved in the embodiments of this application are described. The terms provided in the embodiments of this application are applicable to the following explanations.

(1) In response to: “In response to” is used for representing a condition or status on which one or more operations to be performed depend. When the condition or status is satisfied, the one or more operations may be performed immediately or after a set delay. Unless explicitly stated, there is no limitation on the order in which the plurality of operations are performed.

(2) Virtual scene: A virtual scene is a scene displayed or provided when an application runs on a terminal. The virtual scene may be a simulated environment of the real world, a semi-simulated semi-fictional virtual environment, or a purely fictional virtual environment. The virtual scene may be any one of a two-dimensional virtual scene, a 2.5-dimensional virtual scene, or a three-dimensional virtual scene. Dimensions of the virtual scene are not limited in the embodiments of this application. For example, the virtual scene may include the sky, the land, the sea, or the like. The land may include environmental elements such as deserts and cities. The user may control the virtual object to move in the virtual scene.

(3) Virtual item: A virtual item is an item that can be used by a virtual object in the virtual scene, and is structurally formed by a plurality of components. For example, the virtual item may be a virtual shooting item, such as a virtual firearm or a virtual bow and arrow, for attacking other virtual objects. Alternatively, the virtual item may be a virtual vehicle, such as a virtual car, a virtual ship, a virtual aircraft, or a virtual bicycle, for the virtual object to drive in the virtual scene.

(4) Virtual object: Virtual objects are images of various people and objects that can interact in the virtual scene, or movable objects in the virtual scene. The movable object may be a virtual character, a virtual animal, a cartoon character, or the like, such as a character or an animal displayed in the virtual scene. The virtual object may be a virtual avatar configured for representing a user in the virtual scene. The virtual scene may include a plurality of virtual object, and each virtual object has a shape and a volume in the virtual scene, and occupies some space in the virtual scene.

(5) Scene data: Scene data represents feature data of the virtual scene, for example, may be an area of a construction region in the virtual scene, or a current architectural style of the virtual scene. Alternatively, the scene data may include a position of a virtual building in the virtual scene, an area occupied by the virtual building, or the like.

(6) Client: A client is an application program, such as a video playback client, or a game client, running in a terminal device to provide various services.

(7) Virtual item processing: Virtual item processing means making changes to virtual items, including color updates, structural modifications, or the like. Modification of a virtual item is used as an example. The modification is an operation of changing a structure of the virtual item, including operations of dismantling, installing, and replacing components of the virtual item. For example, a new muzzle may be used to replace an original muzzle of a virtual firearm, or accessories such as a front grip and a laser equipment are installed on a handguard.

The embodiments of this application provide a virtual item processing method and apparatus, an electronic device, a computer-readable storage medium, and a computer program product, and can improve virtual item processing efficiency. To make it easier to understand the virtual item processing method according to the embodiments of this application, the exemplary implementation scenario of the virtual item processing method according to the embodiments of this application is first explained. The virtual scene in the virtual item processing method according to the embodiments of this application may be completely outputted by a terminal device, or may be cooperatively outputted by a terminal device and a server.

In some embodiments, the virtual scene may be an environment for virtual objects (such as game characters) to interact, for example, an environment for game characters to fight in the virtual scene, where two parties can interact in the virtual scene by controlling actions of the game characters, so that the user can relieve life pressure during the game.

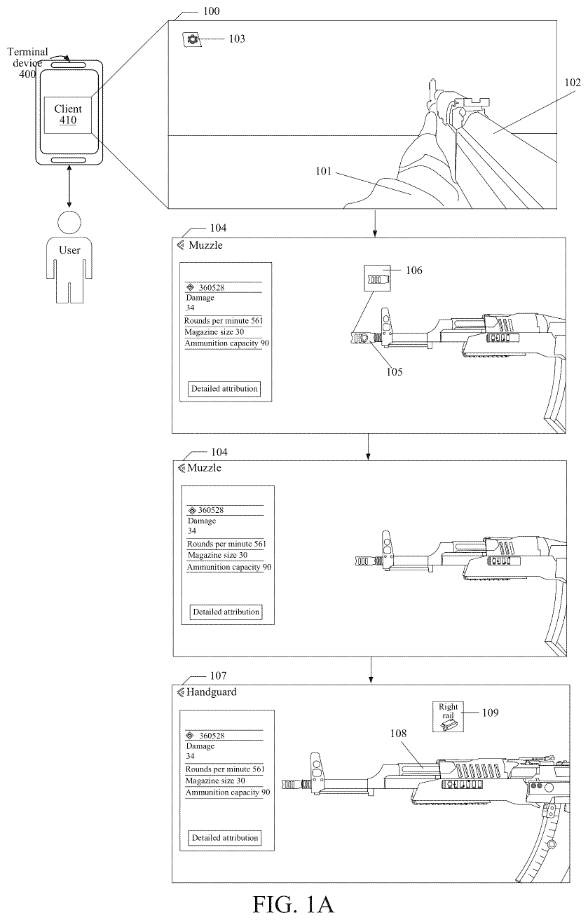

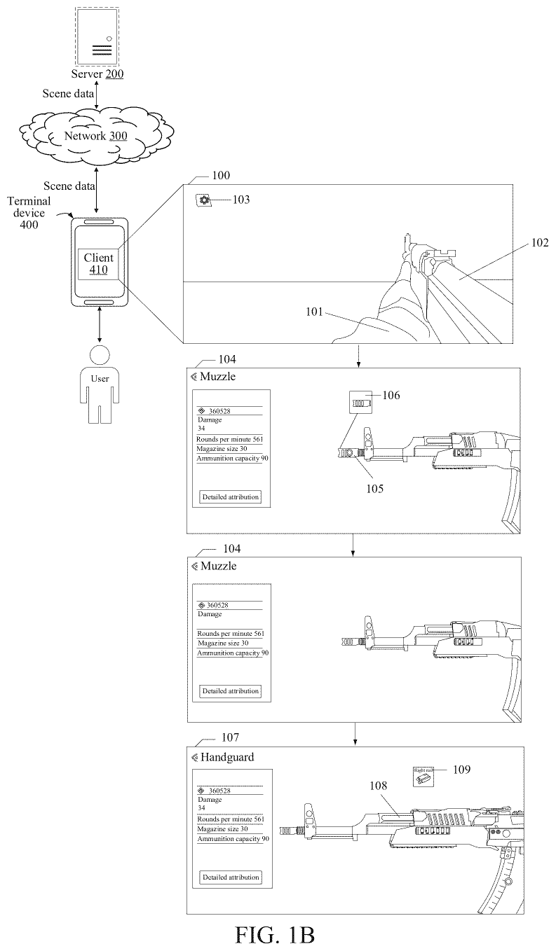

In one embodiment, referring to FIG. 1A, FIG. 1A is a schematic diagram of an application mode of a virtual item processing method according to an embodiment of this application, and is applicable to some application modes, for example, a single-player version/offline mode game, that completely rely on computing power of graphics processing hardware of a terminal device 400 to complete calculation of related data of a virtual scene 100, and the output of the virtual scene is completed by various types of terminal devices 400 such as smartphones, tablets, and virtual reality/augmented reality devices.

For example, types of graphics processing hardware include a central processing unit (CPU) and a graphics processing unit (GPU).

When forming visual perception of the virtual scene 100, the terminal device 400 calculates data required for display by using the graphics computing hardware, and completes loading, parsing, and rendering of the display data, and outputs a video frame capable of forming the visual perception of the virtual scene in the graphics output hardware. For example, a two-dimensional video frame is presented on a display screen of a smartphone, or a video frame that achieves a three-dimensional display effect is projected on a lens of augmented reality/virtual reality glasses. In addition, to enrich perception effects, the terminal device 400 may further use different hardware to form one or more of auditory perception, tactile perception, motion perception, or taste perception.

In an example, a client 410 (for example, a single-player game application) runs on the terminal device 400, and during the operation of the client 410, a virtual scene including role-playing is outputted. The virtual scene may be an environment for game characters to interact, and for example, may be a plain, street, valley, or the like for the game character to combat. That the virtual scene 100 is displayed in a first-person perspective is used as an example. A virtual object 101 is displayed in the virtual scene 100, the virtual object 101 may be a game character controlled by a user, in other words, the virtual object 101 is controlled by a real user and moves in the virtual scene 100 in response to operation by the real user on a controller (such as a touchscreen, a voice-activated switch, a keyboard, a mouse, or a joystick). For example, when the real user moves the joystick to the right, the virtual object 101 moves to the right in the virtual scene 100, or the user may control the virtual object 101 to remain stationary, jump, perform shooting operations, or the like.

For example, the virtual item is a virtual firearm. The virtual object 101 and a virtual firearm 102 held by the virtual object 101 are displayed in the virtual scene 100. In addition, a processing entrance 103 for the virtual firearm 102 is displayed in the virtual scene 100. When receiving a trigger operation by the user for the processing entrance 103, the client 410 switches the virtual scene 100 displayed in the human-computer interaction interface to a first processing interface 104 (for example, a muzzle processing interface). A first component 105 (for example, the muzzle) of the virtual firearm 102 and a processing control 106 (for example, a modification control that may be used to change a new muzzle for the first component 105) of the first component 105 are displayed in the first processing interface 104. Then, in response to a trigger operation for the processing control 106 of the first component 105, the client 410 may display the first component 105 (for example, a new muzzle) after processing instead of displaying the first component 105 before processing, thereby completing the processing for the muzzle. Subsequently, in response to an interface jump trigger operation based on the first processing interface 104, the client 410 may switch directly from displaying the first processing interface 104 to displaying a second processing interface 107 (for example, a handguard processing interface), where a second component 108 (for example, the handguard) of the virtual firearm 102 and a processing control 109 (for example, a right guide rail that can be mounted on the second component 108) of the second component 108 are displayed in the second processing interface 107. In this way, after processing one component, it is possible to quickly jump directly from the processing interface of the component to a processing interface of another component without repeatedly returning to a previous level (for example, a whole gun interface) to select a new processing component, which saves operation time and further improves the virtual item processing efficiency.

In another embodiment, referring to FIG. 1B, FIG. 1B is a schematic diagram of an application mode of a virtual item processing method according to an embodiment of this application, which is applied to a terminal device 400 and a server 200, and is applicable to an application mode in which the virtual scene calculation is completed depending on the computing power of the server 200, and the virtual scene is output at the terminal device 400.

Formation of visual perception of the virtual scene 100 is used as an example, the server 200 calculates display data (for example, scene data) related to the virtual scene and transmits the display data to the terminal device 400 through a network 300. The terminal device 400 relies on the graphics computing hardware to complete the loading, parsing and rendering of the calculated display data, and relies on the graphics output hardware to output the virtual scene to form the visual perception. For example, a two-dimensional video frame is presented on a display screen of a smartphone, or a video frame that achieves a three-dimensional display effect is projected on a lens of augmented reality/virtual reality glasses. Perception of the virtual scene in a form may be outputted by using corresponding hardware of the terminal device 400, for example, the auditory perception may be formed by using a microphone, and the tactile perception may be formed by using a vibrator.

In an example, a client 410 (for example, an online version of a game application) is running on the terminal device 400, and game interaction with other users is performed by connecting to the server 200 (for example, a game server). The terminal device 400 outputs a virtual scene 100 of the client 410. That the virtual scene 100 is displayed in a first-person perspective is used as an example. A virtual object 101 is displayed in the virtual scene 100, the virtual object 101 may be a game character controlled by a user, in other words, the virtual object 101 is controlled by a real user and moves in the virtual scene 100 in response to operation by the real user on a controller (such as a touchscreen, a voice-activated switch, a keyboard, a mouse, or a joystick). For example, when the real user moves the joystick to the right, the virtual object 101 moves to the right in the virtual scene 100, or the user may control the virtual object 101 to remain stationary, jump, perform shooting operations, or the like.

For example, the virtual item is a virtual firearm. The virtual object 101 and a virtual firearm 102 held by the virtual object 101 are displayed in the virtual scene 100. In addition, a processing entrance 103 for the virtual firearm 102 is displayed in the virtual scene 100. When receiving a trigger operation by the user for the processing entrance 103, the client 410 switches the virtual scene 100 displayed in the human-computer interaction interface to a first processing interface 104 (for example, a muzzle processing interface). A first component 105 (for example, the muzzle) of the virtual firearm 102 and a processing control 106 (for example, for changing a new muzzle for the first component 105) of the first component 105 are displayed in the first processing interface 104. Then, in response to a trigger operation for the processing control 106 of the first component 105, the client 410 may display the first component 105 (for example, a new muzzle) after processing instead of displaying the first component 105 before processing, thereby completing the processing for the muzzle. Subsequently, in response to an interface jump trigger operation based on the first processing interface 104, the client 410 switches directly from displaying the first processing interface 104 to displaying a second processing interface 107 (for example, a handguard processing interface), where a second component 108 (for example, the handguard) of the virtual firearm 102 and a processing control 109 (for example, a right guide rail that can be mounted on the second component 108) of the second component 108 are displayed in the second processing interface 107. In this way, after processing one component, it is possible to quickly jump directly from the processing interface of the component to a processing interface of another component without repeatedly returning to a previous level (for example, a whole gun interface) to select a new processing component, which saves operation time and further improves the virtual item processing efficiency.

In some embodiments, the terminal device 400 may alternatively implement the virtual item processing method according to the embodiments of this application by running a computer program. For example, the computer program may be a native program or software module in an operating system; may be a native application (APP), to be specific, a program that needs to be installed in the operating system to run, such as a shooting game APP (namely, the foregoing client 410); It can also be an applet, to be specific, a program that only needs to be downloaded to a browser environment to run. In conclusion, the foregoing computer program may be any form of application, module, or plug-in.

That the computer program is an application is used as an example. In actual implementation, an application that supports the virtual scene is installed and runs on the terminal device 400. The application may be any of a first-person shooting (FPS) game, a third-person shooting game, a virtual reality application, a three-dimensional map program, or a multiplayer gunfight survival game. The user uses the terminal device 400 to operate a virtual object located in the virtual scene to perform activities including but are not limited to: at least one of adjusting body posture, crawling, walking, running, riding, jumping, driving, picking, shooting, attacking, throwing, or building a virtual building. For example, the virtual role may be a virtual character, such as a simulated character role or an animated character role.

In some other embodiments, the embodiments of this application may alternatively be implemented by using the cloud technology. The cloud technology is a hosting technology that unifies a series of resources such as hardware, software, and networks in a wide area network or a local area network to realize data calculation, storage, processing, and sharing.

The cloud technology is a collective name for a network technology, an information technology, an integration technology, a management platform technology, an application technology, and the like based on an application of a cloud computing business mode, and may form a resource pool, which is used as required, and is flexible and convenient. The cloud computing technology becomes an important support. Background services of a technical network system require a large amount of computing and a large quantity of storage resources.

For example, the server 200 in FIG. 1B may be an independent physical server, or a server cluster or a distributed system including a plurality of physical servers, or may alternatively be a cloud server providing basic cloud computing services such as cloud services, cloud databases, cloud computing, cloud functions, cloud storage, network services, cloud communication, middleware services, domain name services, security services, content delivery networks (CDNs), and big data and artificial intelligence platforms. The terminal device 400 may be a smartphone, a tablet computer, a notebook computer, a desktop computer, a smart speaker, a smart watch, or the like, but is not limited thereto. The terminal device 400 and the server 200 may be directly or indirectly connected through wired or wireless communication, and this is not limited in the embodiments of this application.

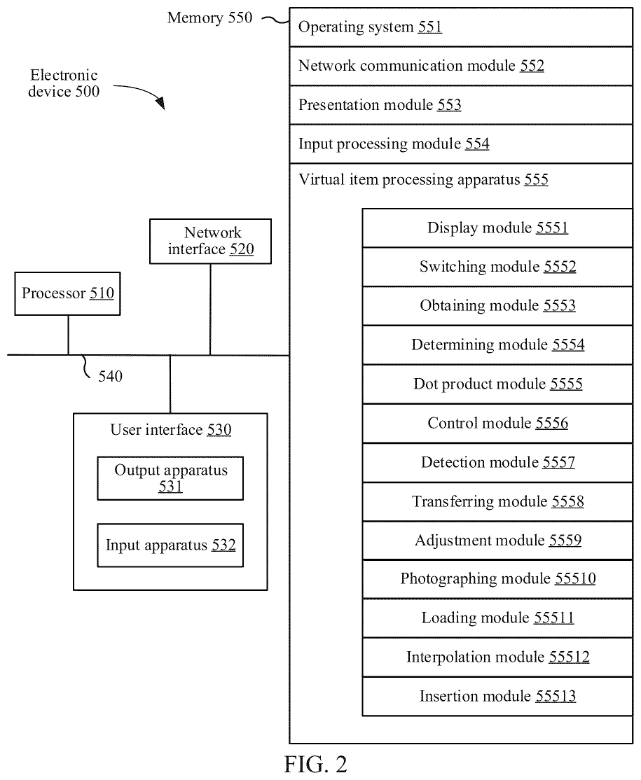

The following continues to describe a structure of an electronic device according to an embodiment of this application. For example, the electronic device is a terminal device. Referring to FIG. 2, FIG. 2 is a schematic structural diagram of an electronic device 500 according to an embodiment of this application. The electronic device 500 shown in FIG. 2 includes at least one processor 510, a memory 550, at least one network interface 520, and a user interface 530. All the components in the electronic device 500 are coupled together by using a bus system 540. The bus system 540 is configured to implement connection and communication between the components. In addition to a data bus, the bus system 540 further includes a power bus, a control bus, and a status signal bus. However, for clarity of description, the various buses are marked as the bus system 540 in FIG. 2.

The processor 510 may be an integrated circuit chip having a signal processing capability, for example, a general purpose processor, a digital signal processor (DSP), or another programmable logic device (PLD), discrete gate, transistor logical device, or discrete hardware component. The general purpose processor may be a microprocessor, any conventional processor, or the like.

The user interface 530 includes one or more output devices 531 that enable presentation of media content, including one or more speakers and/or one or more visual displays. The user interface 530 further includes one or more input devices 532, including user interface components that facilitate user input, such as a keyboard, a mouse, a microphone, a touchscreen, a camera, and other input buttons and controls.

The memory 550 may be removable, non-removable, or a combination thereof. Exemplary hardware devices include a solid-state memory, a hard disk drive, an optical disc driver, or the like. In some embodiments, the memory 550 includes one or more storage devices that are physically located away from the processor 510.

The memory 550 includes a volatile memory or a non-volatile memory, or may include both a volatile memory and a non-volatile memory. The non-volatile memory may be a read-only memory (ROM). The volatile memory may be a random access memory (RAM). The memory 550 described in this embodiment of this application is to include any other suitable type of memories.

In some embodiments, the memory 550 may store data to support various operations. Examples of the data include a program, a module, and a data structure, or a subset or a superset thereof, which are described below by using examples.

An operating system 551 includes a system program configured to process various basic system services and perform a hardware-related task, such as a framework layer, a core library layer, or a driver layer, and is configured to implement various basic services and process a hardware-based task.

A network communication module 552 is configured to access other computing devices via one or more (wired or wireless) network interfaces 520, exemplary network interfaces 520 including: Bluetooth, wireless fidelity (Wi-Fi), universal serial bus (USB), and the like.

A presentation module 553 is configured to enable presentation of information (for example, a user interface for operating peripheral devices and displaying content and information) through one or more output devices 531 (for example, display screens or speakers) associated with the user interface 530.

An input processing module 554 is configured to: perform detection on one or more user inputs or interactions from one or more input devices 532, and translate the detected inputs or interactions.

In some embodiments, the apparatus provided in the embodiments of this application may be implemented in a software manner. FIG. 2 shows a virtual item processing apparatus 555 stored in the memory 550, which may be software in a form of a program or a plug-in, and includes the following software modules: a display module 5551, a switching module 5552, an obtaining module 5553, a determining module 5554, a dot product module 5555, a control module 5556, a detection module 5557, a transfer module 5558, an adjustment module 5559, a photographing module 55510, a loading module 55511, an interpolation module 55512, and an insertion module 55513. These modules are logical and may be combined in any manner or further split according to the functions realized. For ease of illustration, all the foregoing modules are shown in FIG. 2, but it is not considered that the virtual item processing apparatus 555 excludes an implementation in which only the display module 5551 and the switching module 5552 may be included. Functions of the modules are explained below.

The virtual item processing method according to the embodiments of this application are specifically explained below with reference to exemplary application and implementation of the terminal device provided in the embodiments of this application.

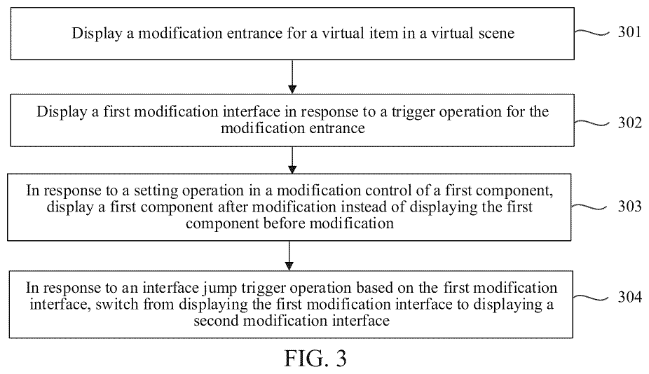

Referring to FIG. 3, FIG. 3 is a schematic flowchart of a virtual item processing method according to an embodiment of this application, which is described with reference to operations shown in FIG. 3.

The method shown in FIG. 3 may be performed by various forms of computer programs run by the terminal device, for example, the operating system, software module, script, or applet described above, but not limited to the client. Therefore, examples of the client below are not to be regarded as limitation to the embodiments of this application. In addition, for ease of illustration, no specific distinction is made between a terminal device and a client running on a terminal device in the following.

Operation 301: Display a processing entrance for a virtual item in a virtual scene.

In some embodiments, a client supporting the virtual scene is installed on the terminal device (for example, when the virtual scene is a game, the corresponding client may be a shooting game APP), and when the user enables the client installed on the terminal device (for example, the user taps an icon corresponding to the shooting game APP presented in a user interface of the terminal device), and the terminal device runs the client, a virtual object (for example, a virtual object A controlled by a user 1) and a virtual item (for example, a virtual shooting item or a virtual throwing item) held by the virtual object A through a holding part (for example, a hand) can be displayed in the virtual scene presented in a human-computer interaction interface of the client. In addition, a processing entrance for the virtual item may be further displayed in the virtual scene, for example, when the virtual item is a virtual firearm, the processing entrance for the virtual firearm may be displayed in the virtual scene.

Operation 302: Display a first processing interface in response to a trigger operation for the processing entrance.

In some embodiments, the first processing interface includes at least a processing control. In some other embodiments, the first processing interface may further include a first component of the virtual item, where the first component may be any component to be modified in virtual item. In the first processing interface, components of the virtual item other than the first component may be not displayed, may be partially displayed, or may be all displayed. The number of displayed components other than the first component may depend on a scaling ratio of the first processing interface (to be specific, a ratio of a size of the virtual item to a size of the first processing interface). The larger the scaling ratio, the smaller the number of displayed components, which facilitates observation of details of the components; and the smaller the scaling ratio, the greater the number of displayed components, which facilitates observation of an overall structure of the virtual item.

For example, types of processing controls in the first processing interface may include a color control for changing the color and a modification control for modifying. The processing control may be dedicated to processing the first component, in other words, different components each corresponds to a processing control. The processing control may alternatively be generic, in other words, is configured for batch processing on a plurality of components of the virtual item including the first component.

In some embodiments, the terminal device may further perform the following processing before displaying the first processing interface: displaying a virtual item viewing interface, where the virtual item viewing interface includes a plurality of components of the virtual item; and in response to a selection operation for the first component in the virtual item viewing interface, transferring to displaying the first processing interface.

For example, the virtual item is a virtual firearm. When receiving a tap operation by the user on the processing entrance of the virtual firearm, the terminal device may first display a virtual firearm viewing interface (such as a whole firearm interface, in which the entire firearm body of the virtual firearm is displayed, and interactive buttons of all components that can be processed are also displayed). Then, the terminal device displays a first processing interface (for example, a muzzle processing interface) in response to a selection operation by the user for a first component (for example, the muzzle) in the virtual firearm viewing interface (for example, when receiving a tap operation by the user on an interactive button for the muzzle). The first component (for example, the muzzle) of the virtual firearm and a processing control of the muzzle (for example, a new muzzle for replacing the original muzzle) may be displayed in the first processing interface.

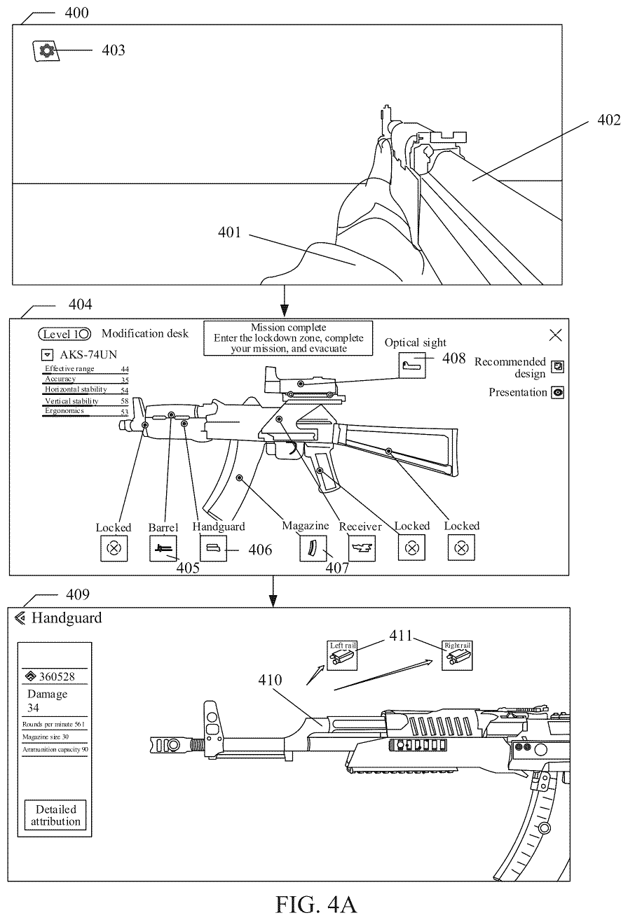

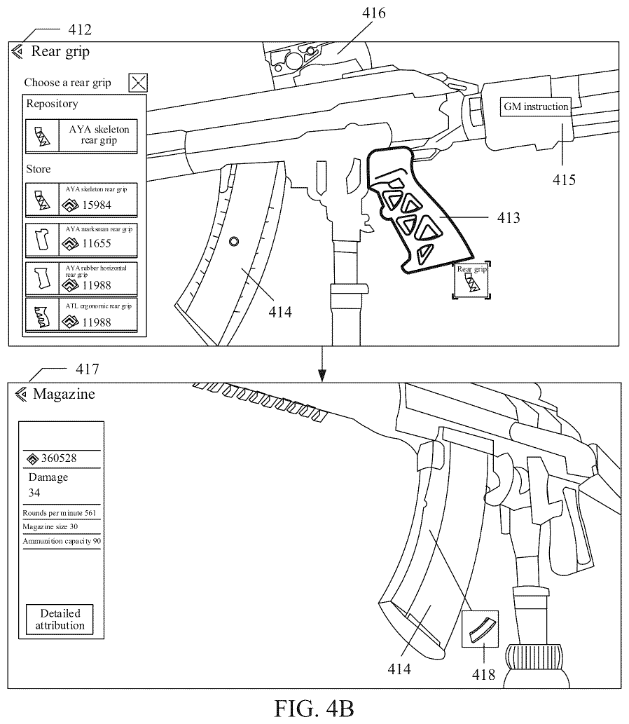

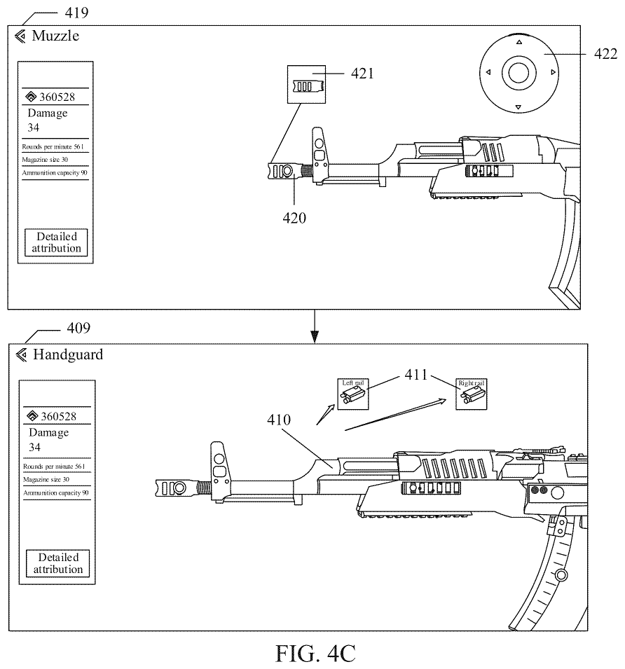

For example, referring to FIG. 4A, FIG. 4A is a schematic diagram of an application scenario of a virtual item processing method according to an embodiment of this application. As shown in FIG. 4A, a virtual scene 400 is displayed in the human-computer interaction interface, and a virtual object 401 (for example, a game character A controlled by the user 1) and a virtual firearm 402 held by the virtual object 401 are displayed in the virtual scene 400. In addition, a processing entrance 403 of the virtual firearm 402 is displayed in the virtual scene 400. When a tap operation for the processing entrance 403 of the virtual firearm 402 is received, the virtual scene 400 displayed in the human-computer interaction interface is switched to a virtual firearm viewing interface 404 (for example, a whole gun interface). A plurality of components, including, for example, a barrel 405, a handguard 406, a magazine 407, and an optical sight 408, of the virtual firearm 402 that can be processed are displayed in the virtual firearm viewing interface 404. When a tap operation for the handguard 406 is received in the virtual firearm viewing interface 404, the virtual firearm viewing interface 404 displayed in the human-computer interaction interface is switched to a handguard processing interface 409, and a handguard 410 of the virtual firearm 402 and a processing control 411 of the handguard 410 (including, for example, left and right rails that can be mounted on the handguard 410) are displayed in the handguard processing interface 409.

Operation 303: In response to a trigger operation for the processing control, display the virtual item after processing instead of displaying the virtual item before processing.

In some embodiments, that the processing control is a universal control is used as an example, in response to a trigger operation for the processing control, batch processing is performed on some or all components of the virtual item, and the processed virtual item is displayed instead of displaying the virtual item before processing. When batch processing is performed on some components of the virtual item, the virtual item before processing is partially substituted for displaying; or when batch processing is performed on all the components of the virtual item, the virtual item before processing is completely substituted for displaying.

In some embodiments, that the first processing interface further includes a first component of the virtual item and a processing control dedicated to the first component is used as an example, the operation 303 may be implemented in the following manner: in response to the trigger operation for the processing control, processing the first component, and displaying the first component after processing instead of displaying the first component before processing. When the virtual item after processing is displayed in the first processing interface, besides displaying the first component, the components in the virtual item other than the first component may be not displayed, may be partially displayed, or may be all displayed. The number of displayed components other than the first component may depend on a scaling ratio of the first processing interface (to be specific, a ratio of a size of the virtual item to a size of the first processing interface). The larger the scaling ratio, the smaller the number of displayed components, which facilitates observation of details of the components; and the smaller the scaling ratio, the greater the number of displayed components, which facilitates observation of an overall structure of the virtual item.

In some embodiments, when receiving a trigger operation by the user for the processing control of the first component, the terminal device may display the first component after processing instead of displaying the first component before processing. For example, the first component is a muzzle of a virtual firearm. When the terminal device receives a trigger operation by a user for a processing control of the muzzle (for example, a selection operation for a new muzzle), the new muzzle may be displayed at a muzzle position of the virtual firearm instead of displaying the original muzzle, thereby completing the processing for the muzzle. For another example, the first component is a handguard of a virtual firearm. When the terminal device receives a trigger operation by the user for a processing control of the handguard (for example, a selection operation for a front grip among a plurality of accessories that can be installed on the handguard), the selected front grip may be installed on the handguard of the virtual firearm, to realize the processing for the handguard.

Operation 304: In response to an interface jump trigger operation, switch from displaying the first processing interface to displaying a second processing interface different from the first processing interface.

A display mode of the second processing interface is similar to a display mode of the first processing interface, for example, the processing control may be displayed in the second processing interface. In some embodiments, a second component may further be displayed in the second processing interface, and the second component may be any component to be modified in the virtual item other than the first component. The processing control in the second processing interface may be universal, in other words, may be configured for batch processing of a plurality of components including the second component of the virtual item. The processing control may alternatively be a control dedicated to modifying the second component, namely, a processing control of the second component.

In some embodiments, the first processing interface may further include the second component of the virtual item, and the interface jump trigger operation may be a trigger operation for the second component. In this case, the terminal device may implement operation 304 in the following manner: in response to a trigger operation for the second component in the first processing interface (for example, a tap operation or an operation of drawing a specific graphic), switching from displaying the first processing interface to displaying the second processing interface.

For example, the first component is a rear grip of a virtual firearm. Referring to FIG. 4B, FIG. 4B is a schematic diagram of an application scenario of a virtual item processing method according to an embodiment of the present application. As shown in FIG. 4B, in addition to the rear grip 413 of the virtual firearm, other components of the virtual firearm are displayed in the processing interface 412 of the rear grip, including, for example, a magazine 414, a stock 415, and a sight 416. When receiving a tap operation by the player for the magazine 414 (namely, the second component) displayed in the processing interface 412 of the rear grip, the processing interface 412 of the rear grip displayed in the human-computer interaction interface is directly switched to a processing interface 417 of the magazine, and the magazine 414 of the virtual firearm and a processing control 418 of the magazine 414 (for example, a new magazine for expanding a capacity of the magazine 414) are displayed in the processing interface 417 of the magazine. In this way, by tapping a component of the firearm model, the player can quickly jump from a processing interface of one component to a processing interface of another component, and the virtual item processing efficiency is improved.

In some other embodiments, the first processing interface may further include at least one browsing control respectively corresponding to at least one direction, and the interface jump trigger operation may be a trigger operation for the browsing control. In this case, the terminal device may implement the operation 304 in the following manner: in response to a trigger operation for a browsing control corresponding to a first direction in the first processing interface, switching from displaying the first processing interface to displaying the second processing interface, a distribution direction of the second component relative to the first component being an opposite direction of the first direction, and the second component being a component closest to the first component in the opposite direction.

For example, the muzzle of the virtual firearm is the first component. Referring to FIG. 4C, FIG. 4C is a schematic diagram of an application scenario of a virtual item processing method according to an embodiment of this application. As shown in FIG. 4C, in addition to a muzzle 420 and a processing control 421 of the muzzle 420 (for example, a new muzzle for replacing the muzzle 420) displayed in a muzzle processing interface 419, a browsing control 422 including four directions: up, down, left, and right, is displayed in the muzzle processing interface 419. When receiving a tap operation by the user on a left direction button of the browsing control 422 (because the handguard is a component located on the right side of the muzzle and the closest to the muzzle in the virtual firearm), the terminal device directly switches the processing interface 419 of the muzzle displayed in the human-computer interaction interface to the processing interface 409 of the handguard, and the handguard 410 and the processing controls 411 (for example, left and right guide rails for installation on the handguard 410) of the handguard 410 are displayed in the processing interface 409 of the handguard, so that through the trigger operation for the browsing control, the player can quickly jump from the processing interface of one component to the processing interface of another component, and the virtual item processing efficiency is improved.

In some embodiments, the interface jump trigger operation may alternatively be a slide operation, and the terminal device may implement the operation 304 in the following manner: in response to the slide operation of which a slide direction of the slide operation is located in a first direction range (to be specific, a sub-range of sliding outward from the first component for a direction range of 0 to 360 degrees, for example, an upward direction perpendicular to the muzzle may be used as 0 degrees, and 0 to 360 degrees are divided into different direction ranges, where the first direction range may be 225 degrees to 315 degrees, in other words, a range centered on the positive left (to be specific, 270 degrees) of the muzzle) of the first component in the first processing interface, directly switching from displaying the first processing interface to displaying the second processing interface. A second component of the virtual item is distributed in an opposite range of the first direction range, where the opposite range of the first direction range is a range formed by the opposite directions of two boundary directions of the first direction range, for example, assuming that the first direction interval is 225 degrees to 315 degrees, the opposite range is 45 degrees to 135 degrees, in other words, a range centered on the positive right (to be specific, 90 degrees) of the muzzle. The distance between the second component and the first component is proportional to a slide distance of the slide operation, to be specific, the greater the slide distance of the slide operation, the greater the distance between the second component and the first component.

For example, the virtual item is a virtual firearm. On the right side of a muzzle, a handguard, a receiver, and a stock are distributed in sequence according to the distance from the muzzle from near to far, so that distance thresholds of two different levels may be preset: L1 (for example, 1 cm) and L2 (for example, 2 cm). When the slide distance of the slide operation is less than or equal to L1 (for example, is 0.7 cm), the terminal device directly switches from a muzzle processing interface displayed in the human-computer interaction interface to a handguard processing interface; when the slide distance of the slide operation is greater than L1, and less than or equal to L2 (for example, is 1.4 cm), the terminal device directly switches from the muzzle processing interface displayed in the human-computer interaction interface to a receiver processing interface; or when the slide distance of the slide operation is greater than L2 (for example, is 2.3 cm), the terminal device directly switches from the muzzle processing interface displayed in the human-computer interaction interface to a stock processing interface. In this way, a user can flexibly jump from the muzzle processing interface to processing interfaces of different components based on the slide distance of the slide operation, in other words, the user can control the slide distance of the slide operation according to a requirement of the user, to jump to a processing interface of a corresponding component, which greatly improves virtual firearm processing efficiency.

In some embodiments, the interface jump trigger operation may be a slide operation. In this case, the terminal device may implement the operation 304 in the following manner: in response to the slide operation in the first processing interface (for example, the muzzle processing interface) and the slide direction of the slide operation being located in the first direction range (for example, may be 225 degrees to 315 degrees of the muzzle) of the first component, directly switching from displaying the first processing interface to displaying the second processing interface, the second component of the virtual item being distributed in an opposite range of the first direction interval (for example, 45 degrees to 135 degrees of the muzzle), and the second component being a component (for example, the handguard) closest to the first component in the opposite range.

For example, the virtual item is a virtual firearm. On the right side of a muzzle, a handguard, a receiver, and a stock are distributed in sequence according to the distance from the muzzle from near to far (that is, the handguard is the component closest to the muzzle). In response to the slide operation in the muzzle processing interface and the slide direction of the slide operation being located in the first direction range of the muzzle (for example, 225 degrees to 315 degrees of the muzzle, in other words, in a range centered on the left side (to be specific, 270 degrees) of the muzzle, where the handguard closest to the muzzle is distributed in an opposite range of the first direction range, for example, 45 degrees to 135 degrees of the muzzle, in other words, in a range centered on the right side (to be specific, 90 degrees) of the muzzle), the terminal device may directly switch the muzzle processing interface displayed in the human-computer interaction interface to the handguard processing interface. In this way, through the slide operation, the user can quickly jump from a processing interface of one component to a processing interface of another component, thereby improving virtual firearm processing efficiency, and improving game experience of the user.

In some other embodiments, the processing interface corresponding to each component may alternatively be pre-configured with a corresponding slide parameter, and the terminal device may implement the foregoing in response to the slide operation of which a slide direction of the slide operation is located in a first direction range of the first component in the first processing interface, switching from displaying the first processing interface to displaying the second processing interface in the following manner: obtaining a first slide parameter configured for the first processing interface, the first slide parameter including at least one direction range of the first component, the at least one direction range including the first direction range, and a component of the virtual item being distributed in an opposite range of each direction range; obtaining an angle value of the slide operation in response to the slide operation in the first processing interface; and in response to the angle value of the slide operation being located in the first direction range in the at least one direction range, switching from displaying the first processing interface to displaying the second processing interface.

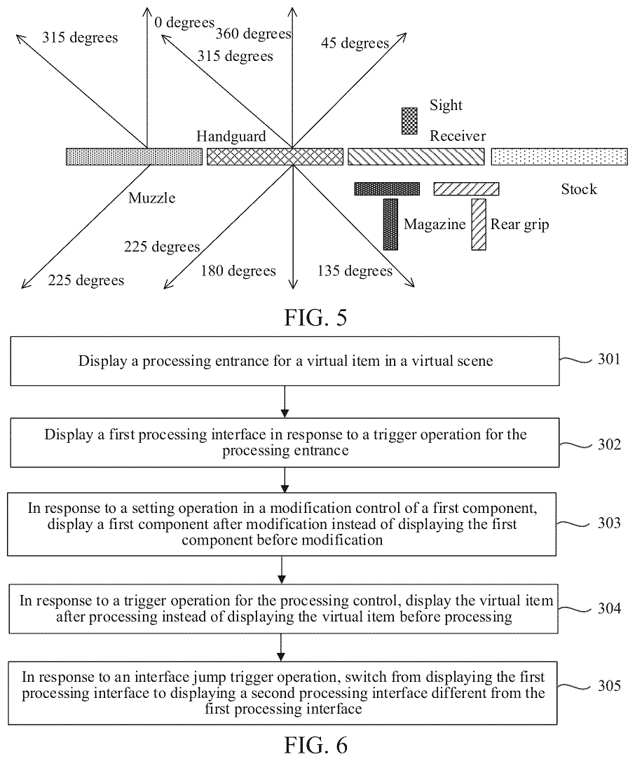

For example, the virtual item is a virtual rifle. Referring to FIG. 5, FIG. 5 is a schematic structural diagram of a virtual rifle according to an embodiment of this application. As shown in FIG. 5, the following components in the virtual rifle may be processed: a muzzle, a handguard, a receiver, a magazine, a sight, a rear grip, and a stock. The handguard is located on the right side of the muzzle, the receiver is located on the right side of the handguard, the sight is located on the upper right side of the handguard, the magazine is located on the lower right side of the handguard, the rear grip is located on the lower side of the receiver, and the stock is located on the right side of the receiver. The muzzle is used as an example. Because there is only one component: the handguard, on the right side of the muzzle, for a muzzle processing interface, only one direction range of the muzzle can be configured. For example, the center point of the muzzle may be used as a start point, and an angle corresponding to an upward direction perpendicular to the muzzle (herein upward means pointing to the upper part of the screen) may be set to 0 degrees, and 0 degrees to 360 degrees may be divided into different direction ranges of the muzzle clockwise. For example, for a slide operation received in the muzzle processing interface, when a slide direction of the slide operation is in a first direction range of the muzzle (for example, 225 degrees to 315 degrees of the muzzle, where the handguard is distributed in an opposite range of the first direction range of the muzzle), the muzzle processing interface is switched to a handguard processing interface.

The handguard is used as another example. Because there are four components (including the muzzle, the receiver, the sight, and the magazine) adjacent to the handguard in the virtual rifle, for the handguard processing interface, four direction ranges of the handguard may be configured. For example, the center point of the handguard may be used as a start point, an angle corresponding to an upward direction perpendicular to the handguard may be set to 0 degrees, and 0 degrees to 360 degrees may be divided into different direction ranges of the handguard clockwise. For example, for a slide operation received in the handguard processing interface, when a slide direction of the slide operation is in a first direction range of the handguard (for example, 45 degrees to 135 degrees of the handguard, where the muzzle is distributed in an opposite range of the first direction range of the handguard), the handguard processing interface is switched to the muzzle processing interface; when the slide direction of the slide operation is in a second direction range of the handguard (for example, 180 degrees to 225 degrees of the handguard, where the sight is distributed in an opposite range of the second direction range of the handguard), the handguard processing interface is switched to a sight processing interface; when the slide direction of the slide operation is in a third direction range of the handguard (for example, 225 degrees to 315 degrees of the handguard, where the receiver is distributed in an opposite range of the third direction range of the handguard), the handguard processing interface is switched to a receiver processing interface; or when the slide direction of the slide operation is in a fourth direction range of the handguard (for example, 315 degrees to 360 degrees of the handguard, where the magazine is distributed in an opposite range of the fourth direction range of the handguard), the handguard processing interface is switched to a magazine processing interface.

The manner in which slide parameters are configured for the processing interfaces of other components of the virtual rifle is similar to the manner in which the slide parameters are configured for the processing interfaces of the muzzle and the handguard, which are not described again in detail in the embodiments of this application.

In some other embodiments, the terminal device may obtain the angle value of the slide operation in the following manner: obtaining a start point (assumed to be a point A (x1, y1)) and an end point (assumed to be a point B (x2, y2)) of the slide operation; determining a slide direction of the slide operation based on the start point and the end point, for example, a direction in which the start point points to the end point may be used as the slide direction of the slide operation; and calculating a dot product of a vector of the slide direction and a vector of a reference direction, namely, Base (0, 1), where the dot product processing is an operation of multiplying corresponding values of the two vectors one by one and obtaining the sum, the result of the dot product is a scalar, and the obtained dot product result is used as the angle value of the slide operation.

For example, assuming that the vector of the slide direction is (3, 4), calculating a dot product of (3, 4) and the Base (0, 1) is specifically: multiplying 3 and 0 to obtain 0, and multiplying 4 and 1 to obtain 4. The dot product result is 4 (to be specific, the sum of 0 and 4).

In some embodiments, continuing the foregoing example, the terminal device may alternatively perform the following processing: controlling the virtual item to rotate in the first processing interface in response to the angle value of the slide operation not being located in any one of at least one angle ranges of the first component. The angle of the rotation is a fixed value, for example, every time the user performs a slide operation, the virtual item rotates by 30 degrees. Alternatively, the angle of the rotation is proportional to the slide distance of the slide operation. For example, a proportional coefficient may be pre-configured, and a result of multiplying the slide distance with the proportional coefficient is determined as the rotation angle, so that the user can control the slide distance of the slide operation according to a requirement of the user.

For example, the first component is a muzzle of a virtual rifle. A muzzle processing interface is configured with a corresponding first slide parameter. The first slide parameter includes a first direction range of the muzzle (for example, 225 degrees to 315 degrees of the muzzle). When a slide direction of a slide operation by the user is not in the first direction range of the muzzle (for example, it is assumed that the user swipes the screen to the right, and an angle value of the slide operation is 80 degrees), it may be determined that the current slide operation is not for triggering the interface jump, but simply swiping the screen back and forth to appreciate an appearance of the virtual rifle. Therefore, the virtual rifle may be controlled to rotate in the muzzle processing interface. A rotation angle of the virtual rifle may be proportional to a slide distance of the slide operation. For example, when the slide distance of the slide operation is 1 centimeter, a corresponding rotation angle of the virtual rifle is 50 degrees; and when the slide distance of the slide operation is 2 centimeters, the corresponding rotation angle of the virtual rifle is 100 degrees.

In some other embodiments, before obtaining the angle value of the slide operation, the terminal device may further perform the following processing: performing detection on the slide operation based on the first slide parameter, to obtain a detection result; in response to the detection result representing that the slide operation is the interface jump trigger operation, transferring to obtaining an angle value of the slide operation; or in response to the detection result representing that the slide operation is a virtual item viewing operation, controlling the virtual item to rotate in the first processing interface, an angle of the rotation being a fixed value, or an angle of the rotation being proportional to the slide distance of the slide operation.

For example, the first slide parameter may include at least one of the following parameters: set slide duration (for example, may be minimum slide duration or maximum slide duration), a set slide distance (for example, may be a minimum slide distance or a maximum slide distance), a set pressure parameter (for example, may be a minimum pressure value or a maximum pressure value), or a set number of contacts (for example, may be single-point corresponding to the interface jump trigger operation or double-point corresponding to the interface jump trigger operation).

That the first slide parameter is the set slide duration is used as an example. The terminal device may perform detection on the slide operation based on the first slide parameter to obtain the detection result in the following manner: obtaining slide duration of the slide operation, comparing the slide duration with the set slide duration to obtain a comparison result, and when the comparison result indicates that the slide duration meets a duration condition, determining that the slide operation is the interface jump trigger operation, or when the comparison result indicates that the slide duration does not meet a duration condition, determining that the slide operation is the virtual item viewing operation. For example, when the set slide duration is the minimum slide duration (for example, 1 second), and it is detected that the slide duration of the slide operation is greater than or equal to the minimum slide duration, it is determined that the duration condition is satisfied; or when the set slide duration is the maximum slide duration (for example, 2 second), and it is detected that the slide duration of the slide operation is less than the maximum slide duration, it is determined that the duration condition is satisfied.

That the first slide parameter is the set slide distance is used as an example. The terminal device may perform detection on the slide operation based on the first slide parameter to obtain the detection result in the following manner: obtaining the slide distance of the slide operation, comparing the slide distance with the set slide distance to obtain a comparison result, and when the comparison result indicates that the slide distance meets a distance condition, determining that the slide operation is the interface jump trigger operation, or when the comparison result indicates that the slide distance does not meet a distance condition, determining that the slide operation is the virtual item viewing operation. For example, when the set slide distance is the minimum slide distance (for example, 1 centimeter), and it is detected that the slide distance of the slide operation is greater than or equal to the minimum slide distance, it is determined that the distance condition is satisfied; or when the set slide distance is the maximum slide distance (for example, 2 centimeter), and it is detected that the slide distance of the slide operation is less than the maximum slide distance, it is determined that the distance condition is satisfied.

That the first slide parameter is the set pressure parameter is used as an example. The terminal device may perform detection on the slide operation based on the first slide parameter to obtain the detection result in the following manner: obtaining a pressure parameter of the slide operation, comparing the pressure parameter with the set pressure parameter to obtain a comparison result, and when the comparison result indicates that the pressure parameter meets a pressure condition, determining that the slide operation is the interface jump trigger operation, or when the comparison result indicates that the pressure parameter does not meet a pressure condition, determining that the slide operation is the virtual item viewing operation. For example, when the set pressure parameter is the minimum pressure threshold, and it is detected that the pressure value of the slide operation is greater than or equal to the minimum pressure threshold, it is determined that the pressure condition is satisfied; or when the set pressure parameter is the maximum pressure threshold, and it is detected that the pressure value of the slide operation is less than the maximum pressure threshold, it is determined that the pressure condition is satisfied.

The foregoing minimum pressure threshold and maximum pressure threshold may be configured. For example, different minimum pressure thresholds or maximum pressure thresholds may be configured for different components of the virtual item, and this is not specifically limited in the embodiments of this application.

That the first slide parameter is the set number of contacts is used as an example. The terminal device may perform detection on the slide operation based on the first slide parameter to obtain the detection result in the following manner: obtaining a number of contacts of the slide operation, comparing the number of contacts with the set number of contacts to obtain a comparison result, and when the number of contacts is equal to the set number of contacts, determining that the slide operation is the interface jump trigger operation, or when the number of contacts is different from the set number of contacts, determining that the slide operation is the virtual item viewing operation. For example, assuming that the set number of contacts is single-point, when the number of contacts of the slide operation is also single-point, it is determined that the slide operation is an interface jump trigger operation; or when the number of contacts of the slide operation is multi-point, it is determined that the slide operation is a virtual item viewing operation.

In some embodiments, the first processing interface and the second processing interface are photographed by a virtual camera, and each component of the virtual item is configured with a lens parameter corresponding to the virtual camera. In this case, before switching from displaying the first processing interface to displaying the second processing interface, the terminal device may further perform the following processing: obtaining a second lens parameter configured for the second component; adjusting a posture of the virtual camera in the virtual scene based on the second lens parameter, and calling the adjusted virtual camera to photograph the virtual item; and loading the processing control of the second component in a picture obtained through the photographing, to obtain the second processing interface.

For example, the lens parameter may include at least one of the following parameters: a component corresponding to a lens (for example, when the lens parameter is a lens parameter configured for the muzzle of the virtual rifle, the component corresponding to the lens is the muzzle), a rotation angle of the lens, an offset of the lens relative to a start point of the component (for example, when the lens parameter is a lens parameter configured for the muzzle of the virtual rifle, the offset is an offset value relative to a start point of the muzzle), a distance between the lens and a focal point, or a viewing angle of the lens.

In some other embodiments, continuing the foregoing example, the terminal device may further perform the following processing: obtaining a first lens parameter configured for the first component; performing interpolation between the first lens parameter and the second lens parameter, to obtain at least one intermediate lens parameter, each intermediate lens parameter being configured for: adjusting the posture of the virtual camera, and calling the adjusted virtual camera to photograph the virtual item, to obtain a corresponding intermediate interface; and inserting at least one intermediate interface during switching from displaying the first processing interface to displaying the second processing interface.

The number of intermediate interfaces inserted in the switching process may be fixed, or may be proportional to a frame rate when displaying the virtual scene, to be specific, the higher the frame rate, the larger the number of intermediate interfaces inserted, so that smooth switching from the first processing interface to the second processing interface can be realized, and the visual experience of the user is improved.

In addition, regardless of whether the first processing interface is directly switched to the second processing interface, or a transition animation is added during the switching process (that is, an intermediate interface is inserted), the essence is to jump from displaying a processing interface of one component to displaying a processing interface of another component, without inserting any interface (such as the whole gun interface) with a third-party function during the process.

For example, the terminal device may implement the foregoing performing interpolation between the first lens parameter and the second lens parameter, to obtain at least one intermediate lens parameter in the following manner: multiplying the second lens parameter with t, to obtain a first multiplication result, t being time elapsed after the switching starts, and a value range of t satisfying: 0≤t≤T, T being total time of switching from the first processing interface to the second processing interface, and T being a real number greater than 0; multiplying a result of subtracting t from T with the first lens parameter, to obtain a second multiplication result; and determine a sum of the first multiplication result and the second multiplication result as the at least one intermediate lens parameter.

In other embodiments, referring to FIG. 6, FIG. 6 is a schematic flowchart of the virtual item processing method according to an embodiment of this application. As shown in FIG. 6, after operation 304 shown in FIG. 3 is executed, operation 305 shown in FIG. 6 may further be executed, which is explained with reference to operations shown in FIG. 6.

Operation 304 is described above with reference to triggering different types of interface jump trigger operations based on the first processing interface. Although the interface jump trigger operations described above are all triggered based on the first processing interface, it is not to be considered as a limitation that the interface jump trigger operation can only be implemented based on the first processing interface. Other situations of the interface jump trigger operation continue to be explained below.

In some embodiments, the interface jump trigger operation may be a voice command. The voice command may indicate a switching direction from the first component. For example, the voice command may be switching to the left, and then the terminal device switches to displaying a second processing interface including a second component, where the second component is a component on the left of the first component and closest to the first component. The voice command may further indicate a number of jump operations. For example, the voice command may be switching to the left by two components, and then the terminal device switches to displaying a second processing interface including a second component, where the second component is on the left of the first component and is spaced from the first component by one component.

In some other embodiments, the interface jump trigger operation may be a somatosensory operation. The somatosensory operation may be an operation of swaying the terminal device in a direction. For example, the somatosensory operation may be swaying to the left, and then the terminal device switches to displaying a second processing interface including a second component, where the second component is a component on the left of the first component and closest to the first component. The somatosensory operation may further indicate a number of jump operations. For example, an amplitude of swaying to the left may be positively correlated with the number of components switched on the left, and the larger the amplitude, the greater the number of components switched on the left.

Operation 305: In response to a third component of the virtual item satisfying a processing condition, switch from displaying the second processing interface to displaying a third processing interface different from the second processing interface.

A display manner of the third processing interface is similar to the display manner of the first processing interface. In some embodiments, the third processing interface includes at least a processing control. In some other embodiments, the third processing interface may further include a third component of the virtual item, and the third component may be any component of the virtual item to be modified other than the first component and the second component.

For example, a type of the processing control in the third processing interface may include a color control for changing a color and a modification control for modification. The processing control may be dedicated to processing the third component, in other words, may be the processing control of the third component. The processing control may alternatively be generic, in other words, is configured for batch processing on a plurality of components of the virtual item including the first component.

In the third processing interface, components other than the third component of the virtual item may be not displayed, may be partially displayed, or may be all displayed. The number of displayed components other than the third component may depend on a scaling ratio of the third processing interface (to be specific, a ratio of a size of the virtual item to a size of the third processing interface). The larger the scaling ratio, the smaller the number of displayed components, which facilitates observation of details of the components; and the smaller the scaling ratio, the greater the number of displayed components, which facilitates observation of an overall structure of the virtual item.

In some embodiments, the interface jump operation may alternatively be automatically implemented, for example, when detecting that the third component of the virtual item satisfies the processing condition, the terminal device may automatically jump from the second processing interface to the third processing interface, where the processing condition may include at least one of the following: a loss degree of the third component (for example, as the user uses the virtual item longer, the third component of the virtual item slowly generates loss; or when the third component of the virtual item of the user is attacked by another player, the third component of the virtual item is also caused generate to loss. When the loss degree of the third component is greater than a loss degree threshold, normal use of the virtual item is affected.

That the third component is the stock of the virtual firearm is used as an example. As the user uses the virtual firearm longer in the game, the stock gradually generates virtual loss, for example, becomes broken or deformed, resulting in abnormal recoil and affecting shooting experience of the user) is greater than or equal to a loss degree threshold (such as 30%); or a new accessory available for use by the third component is obtained. For example, that the third component is the stock of the virtual rifle is used as an example. When detecting that a loss degree of the stock of the virtual rifle is greater than a loss degree threshold (for example, use of the virtual rifle by the user in the game is affected), the terminal device can automatically jump from the second processing interface (for example, the handguard processing interface) to the stock processing interface, thereby facilitating the user to process the stock. In this way, the virtual item processing efficiency is improved, and the game experience of the user is also improved.

According to the virtual item processing method according to the embodiments of this application, when the interface jump trigger operation is received in the first processing interface corresponding to the first component, the terminal device can directly jump from the first processing interface to the second processing interface corresponding to the second component without first returning to an upper level to select the second component. In this way, the virtual item processing efficiency can be greatly improved, and the game experience of the user is improved.

An exemplary application is described below by using an example in which the virtual item as a virtual firearm, and the processing is modification processing.

An embodiment of this application provides a virtual item processing method. Based on relative positions between various components on a virtual firearm, slide operations in different directions are performed or corresponding components are directly tapped, to directly jump from a modification interface of one component to a modification interface of another component (for example, directly jump from a modification interface of a muzzle to a modification interface of a handguard), without repeatedly returning to an upper level (for example, a whole gun interface) to select a new modification component, which greatly improves modification efficiency of the virtual firearm.

The virtual item processing method according to this embodiment of this application is described in detail below.

In some embodiments, a user can quickly jump to a modification interface of a component that needs to be modified in the virtual firearm by tapping the corresponding component.

For example, as shown in FIG. 4B, in addition to a rear grip 413, other components of the virtual firearm, such as a magazine 414, a stock 415, and a sight 416, are displayed in a modification interface 412 of the rear grip. Each firearm component has its own envelope box. When a tap operation by the user on an envelope box of the magazine 414 is received, the modification interface 412 of the rear grip directly jumps to a modification interface 417 of the magazine.

In some other embodiments, the user may alternatively jump between modification interfaces of different components by swiping a screen.

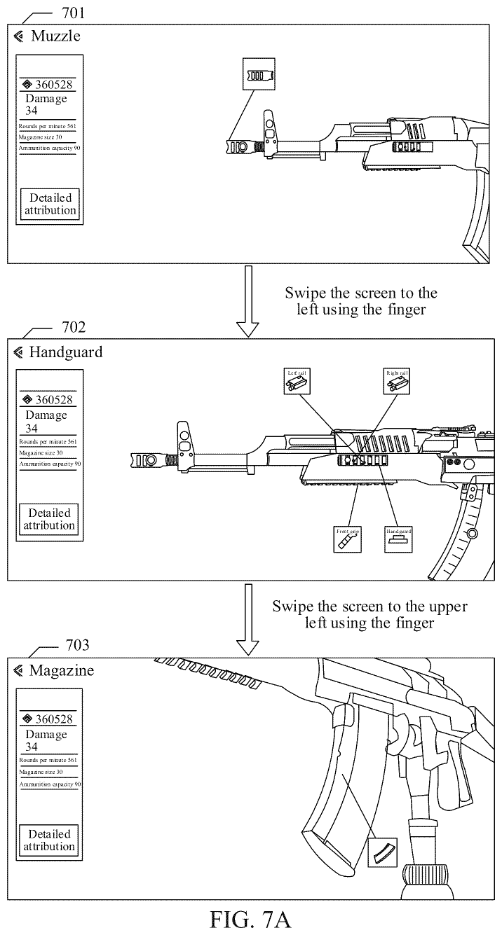

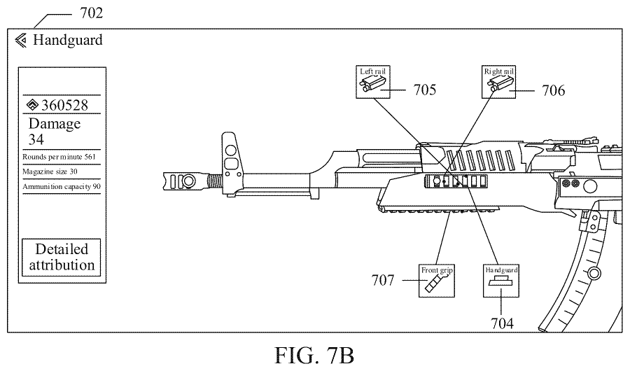

For example, as shown in FIG. 5, the following components in a virtual rifle can be modified: a muzzle, a handguard, a receiver, a sight, a magazine, a rear grip, and a stock. There are relative positions between these components, for example, the handguard is on the right side of the muzzle, the receiver is on the right side of the handguard, the sight is on the upper right side of the handguard, and the magazine is on the lower right side of the handguard. Therefore, as shown in FIG. 7A, assuming that a modification interface 701 of the muzzle is displayed in the human-computer interaction interface, the user only needs to slide the finger to the left to jump from the modification interface 701 of the muzzle to a modification interface 702 of the handguard, because in visual perception, the handguard is on the right side of the muzzle, when the user swipes the screen to the left, the user turns from the muzzle position to the handguard position, in other words, the user jumps from the modification interface 701 of the muzzle to the modification interface 702 of the handguard. Similarly, when a slide operation in which the user swipes the screen to the upper left is received, the modification interface 702 of the handguard is switched to a modification interface 703 of the magazine. Similarly, swiping the screen to the lower left means jumping from the modification interface of the handguard to a modification interface of the sight.

In some other embodiments, a direction range may be set to determine whether a specific slide direction can trigger an interface jump. Still referring to FIG. 5, the muzzle is used as an example. For example, a set direction range for switching from the muzzle to the handguard may be 225 degrees to 315 degrees, so that the client may trigger the interface jump provided that a swipe screen operation within the direction range is detected.

In addition, to distinguish whether the user expects to trigger the interface jump or simply slide back and forth to appreciate an appearance of the firearm, a duration limit for the slide operation may be set. For example, when duration of the slide operation exceeds a duration threshold (for example, 2 seconds), then the interface jump operation is not triggered, and the slide operation is considered as an operation of appreciating the appearance of the firearm.

In some embodiments, because components that can be modified are different for different types of guns, a set of parameters may be separately configured, to determine a jump sequence and an angle range parameter of the swipe screen direction.

For components such as the handguard and the sight, if sub-components (or sub-accessories), for example, a front grip, a flashlight, or laser equipment, can be further added to be installed on the handguard, the handguard and all sub-accessories on the handguard may be uniformly displayed in the modification interface of the handguard. In the modification interface, the handguard and the sub-accessories can be modified together. When a jump operation is performed, the handguard and the sub-accessories are considered as a whole.

For example, referring to FIG. 7B, FIG. 7B is a schematic diagram of an application scenario of a virtual item modification processing method according to an embodiment of this application. As shown in FIG. 7B, in addition to a handguard 704 for replacing an original handguard of the firearm, sub-accessories, including, for example, a left rail 705, a right rail 706, and a front grip 707, that can be further added to be installed on the handguard are also displayed in the modification interface 702 of the handguard. In this way, the handguard and the sub-accessories can be modified together in one modification interface, thereby improving the modification efficiency of the virtual firearm.

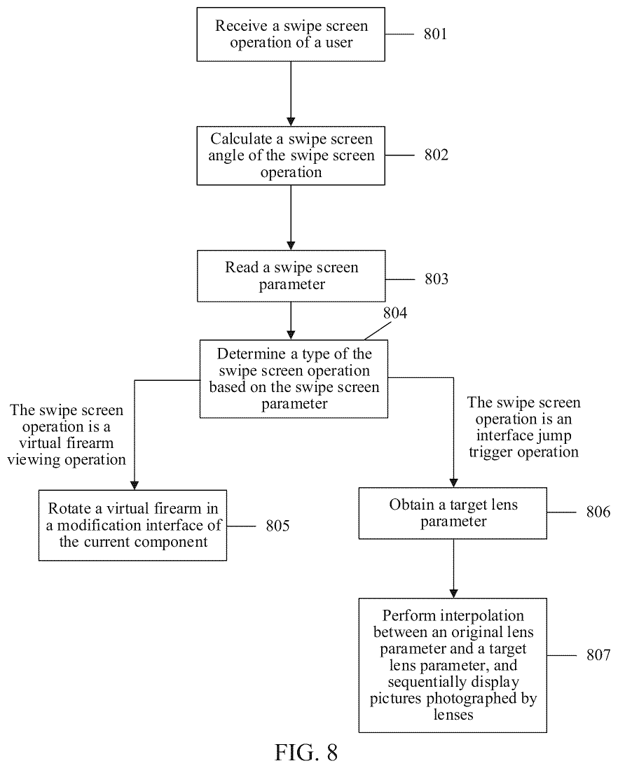

The virtual item processing method according to this embodiment of this application is described in detail below with reference to FIG. 8.

For example, referring to FIG. 8, FIG. 8 is a schematic flowchart of a virtual item processing method according to an embodiment of this application, which is described with reference to operations shown in FIG. 8.

Operation 801: A client receives a swipe screen operation by a player.

In some embodiments, that the currently displayed modification interface is a muzzle modification interface is used as an example, the client receives the swipe screen operation triggered by the player in the muzzle modification interface.

Operation 802: The client calculates a swipe screen angle of the swipe screen operation.

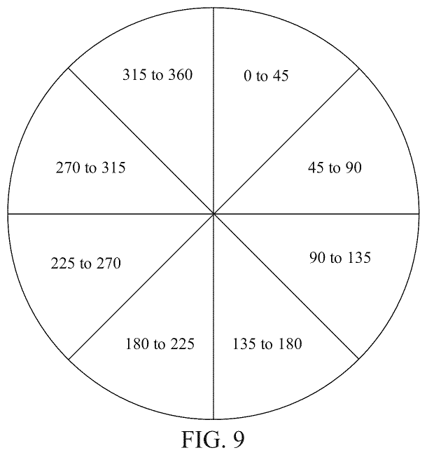

In some embodiments, the muzzle is used as an example. Before calculating the swipe screen angle, as shown in FIG. 5, starting from the center point of the muzzle, the client may set an upward angle perpendicular to the muzzle to 0 degrees, and divide 0 degrees to 360 degrees into eight quadrants as shown in FIG. 9. Then a sixth quadrant and a seventh quadrant (to be specific, 225 degrees to 315 degrees) are determined to be the first direction range of the muzzle, in other words, if an angle value of a swipe screen direction P of the player falls within the sixth quadrant or the sixth quadrant (namely, the first direction range), a jump operation from the modification interface of the muzzle to the modification interface of the handguard is triggered.

Subsequently, the client may obtain a start point A (x1, y1) and an end point B (x2, y2) of the swipe screen operation by the player, calculate the swipe screen direction P from point A to point B (P is a vector pointing from A to B), then calculate a dot product of vectors of the swipe screen direction P and a reference direction, namely, Base (0, 1), use the obtained dot product result as the angle value of the swipe screen direction P of the player, and determine, based on the angle value, a quadrant in which the swipe screen direction P of the player falls.

Operation 803: The client reads a swipe screen parameter.

In some embodiments, for the modification interface corresponding to each component of the virtual firearm, a set of swipe screen parameters (corresponding to the foregoing slide parameters) may be pre-configured to control the swipe screen and jump operations of the player. The swipe screen parameters may include: Min (float) and Max (float), representing a swipe screen range (namely, direction range) required to modify the component, where for example, for jumping from the muzzle to the handguard, the corresponding Min (float) and Max (float) are respectively 225 degrees and 315 degrees (corresponding to the sixth quadrant and the seventh quadrant in FIG. 9, to be specific, if the angle value of the swipe screen direction P of the player falls in the sixth quadrant or the seventh quadrant, a jump operation from the modification interface of the muzzle to the modification interface of the handguard is triggered), MinDist (float) representing the minimum slide distance required, MaxDuration (float) representing the maximum slide duration for triggering the interface jump, and PointType (enum) representing the modified component corresponding to the lens. A swipe screen parameter corresponding to a modification interface of each component may be pre-configured.

Operation 804: The client determines a type of the slide operation based on the slide parameter. When the slide operation is the virtual firearm viewing operation, perform operation 805; when the slide operation is the interface jump trigger operation, perform operations 806 and 807.

Operation 805: The client rotates the virtual firearm in the modification interface of the current component.

In some embodiments, that the currently displayed modification interface is the modification interface of the muzzle is used as an example. When the client determines, based on the swipe screen parameter, that the type of the swipe screen operation is a virtual firearm viewing operation, the virtual firearm may be rotated in the muzzle modification interface, and the rotated virtual firearm may be displayed, to meet the requirement of the player to appreciate the appearance of the firearm.

Operation 806: The client obtains a target lens parameter.

In some embodiments, for each component of the virtual firearm, a set of lens parameters may be pre-configured to describe a lens corresponding to the component. The lens parameters may include: PointType (enum) representing the modified component corresponding to the lens, Rotation (Vector3) representing a rotation angle of the lens, Offset (Vector2) representing an offset of the lens from the initial point, CameraDis (float) representing a distance between the lens and a focal point, FOV (float) from a viewing angle of the lens, and LerpSpeed (float) representing a speed of interpolation transition between the current lens and a next lens.

For example, that the currently displayed modification interface is the modification interface of the muzzle is used as an example. After reading the swipe screen parameters configured for the modification interface of the muzzle, the client first determines whether the slide distance of the current swipe screen operation by the player is greater than the minimum slide distance (MinDist). If the slide distance is less than the MinDist, it is determined that the swipe screen operation is a virtual firearm viewing operation, and the client may rotate the virtual firearm in the modification interface of the muzzle and display the rotated virtual firearm, to meet the requirement of the player to appreciate the appearance of the firearm. If the slide distance is greater than the MinDist, the client continues to determine whether the slide duration of the swipe screen operation by the player is less than the maximum slide duration (MaxDuration). If the slide duration is greater than the MaxDuration, it is determined that the swipe screen operation is a virtual firearm viewing operation, and the client rotates the virtual firearm in the modification interface of the muzzle and displays the rotated virtual firearm, to meet the requirement of the player to appreciate the appearance of the firearm. If the slide duration is less than the MaxDuration, it is determined that the swipe screen operation is an interface jump trigger operation, and the client obtains a corresponding target lens parameter based on a quadrant in which the swipe screen direction P of the player falls. For example, if the angle value of the swipe screen direction P of the player falls in the sixth quadrant or the seventh quadrant, the client obtains a lens parameter configured for the handguard (namely, the target lens parameter).

Operation 807: The client performs interpolation between an initial lens parameter and the target lens parameter, and sequentially displays pictures photographed by the lenses.

In some embodiments, after obtaining the target lens parameter, the client may further perform linear interpolation between each parameter of initial lens parameters (to be specific, lens parameters corresponding to the current modification interface) and the target lens parameter, where the interpolation formula for performing the linear interpolation processing may be:

P=(1−DeltaTime)*A+DeltaTime*B

DeltaTime represents time elapsed after the switching starts, A represents the lens parameter corresponding to the current modification interface, B represents the target lens parameter, and P represents the intermediate lens parameter obtained through the interpolation processing. In this way, the posture of the virtual camera can be adjusted sequentially based on the initial lens parameter, the intermediate lens parameter, and the target lens parameter, and the adjusted virtual camera can be called to photograph the virtual firearm, to obtain the pictures photographed by the virtual camera in different postures (in other words, the pictures photographed by the lens when the virtual camera is in different postures). Finally, a plurality of pictures obtained through the photographing are displayed sequentially, to realize smooth switching from the modification interface of the muzzle to the modification interface of the handguard.

In the virtual item modification processing method provided in the embodiments of this application, based on relative positions between various components on the virtual firearm, swipe screen operations in different directions are performed or the models are directly tapped, to directly jump from a modification interface of one component to a modification interface of another component, without repeatedly returning to an upper level (for example, the whole gun interface) to select a new modification component, which improves modification efficiency of the virtual firearm, and further improves the game experience of the user.

An exemplary structure in which the virtual item modification processing apparatus 555 according to the embodiments of this application is implemented as a software module is described below. In some embodiments, as shown in FIG. 2, software modules of the virtual item modification processing apparatus 555 stored in the memory 550 may include a display module 5551 and a switching module 5552.

The display module 5551 is configured to display a modification entrance for a virtual item in a virtual scene. The display module 5551 is further configured to display a first processing interface in response to a trigger operation for a processing entrance, the first processing interface including at least a processing control. The display module 5551 is further configured to: in response to a trigger operation for the processing control, display a virtual item after processing instead of displaying the virtual item before processing. The switching module 5552 is configured to: in response to an interface jump trigger operation, switch from displaying the first processing interface to displaying a second processing interface different from the first processing interface.

In some embodiments, the first processing interface further includes a first component of the virtual item. The display module 5551 is further configured to: in response to the trigger operation for the processing control, display the first component after processing instead of displaying the first component before processing, components in the virtual item after processing other than the first component being not displayed or being at least partially displayed.

In some embodiments, the first processing interface further includes a second component of the virtual item, and the interface jump trigger operation is a trigger operation for the second component. The switching module 5552 is further configured to: in response to a trigger operation for the second component in the first processing interface, switch from displaying the first processing interface to displaying the second processing interface.

In some embodiments, the first processing interface further includes at least one browsing control respectively corresponding to at least one direction, and the interface jump trigger operation is a trigger operation for the browsing control. The switching module 5552 is further configured to: in response to a trigger operation for a browsing control corresponding to a first direction in the first processing interface, switch from displaying the first processing interface to displaying the second processing interface, a distribution direction of the second component relative to the first component being an opposite direction of the first direction, and the second component being a component closest to the first component in the opposite direction.

In some embodiments, the interface jump trigger operation is a slide operation. The switching module 5552 is further configured to: in response to the slide operation of which a slide direction of the slide operation is located in a first direction range of the first component in the first processing interface, switching from displaying the first processing interface to displaying the second processing interface, a second component being distributed in a opposite range of the first direction range, and a distance between the second component and the first component being proportional to a slide distance of the slide operation.

In some embodiments, the interface jump trigger operation is a slide operation. The switching module 5552 is further configured to: in response to the slide operation of which a slide direction of the slide operation is located in a first direction range of the first component in the first processing interface, switch from displaying the first processing interface to displaying the second processing interface, a second component being distributed in a opposite range of the first direction range, and the second component being a component closest to the first component in the opposite range.

In some embodiments, the virtual item processing apparatus 555 further includes an obtaining module 5553, configured to obtain a first slide parameter configured for the first processing interface, the first slide parameter including at least one direction range of the first component, the at least one direction range including the first direction range, and a component of the virtual item being distributed in an opposite range of each direction range. The obtaining module 5553 is further configured to obtain an angle value of the slide operation in response to the slide operation in the first processing interface. The switching module 5552 is further configured to: in response to the angle value of the slide operation being located in the first direction range in the at least one direction range, switching from displaying the first processing interface to displaying the second processing interface.

In some embodiments, the obtaining module 5553 is further configured to obtain a start point and an end point of the slide operation. The virtual item processing apparatus 555 further includes a determining module 5554 and a dot product module 5555. The determining module 5554 is configured to determine a slide direction of the slide operation based on the start point and the end point. The dot product module 5555 is configured to calculate a dot product of the slide direction and a reference direction, to obtain the angle value of the slide operation.

In some embodiments, the virtual item processing apparatus 555 further includes a control module 5556, configured to: in response to the angle value of the slide operation not being in any one of the at least one angle range, control the virtual item to rotate in the first processing interface, an angle of the rotation being a fixed value, or an angle of the rotation being proportional to a slide distance of the slide operation.

In some embodiments, the virtual item processing apparatus 555 further includes a detection module 5557 and a transferring module 5558. The detection module 5557 is configured to perform detection on the slide operation based on the first slide parameter before the obtaining module 5553 obtains the angle value of the slide operation, to obtain a detection result. The transferring module 5558 is configured to: in response to the detection result representing that the slide operation is the interface jump trigger operation, transfer to obtaining an angle value of the slide operation. The control module 5556 is configured to: in response to the detection result representing that the slide operation is a virtual item viewing operation, control the virtual item to rotate in the first processing interface, an angle of the rotation being a fixed value, or an angle of the rotation being proportional to the slide distance of the slide operation.

In some embodiments, the first slide parameter further includes at least one of the following parameters: set slide duration, a set slide distance, a set pressure parameter, or a set number of contacts. The detection module 5557 is further configured to perform at least one of the following operations: obtaining slide duration of the slide operation, comparing the slide duration with the set slide duration to obtain a comparison result, and when the comparison result indicates that the slide duration meets a duration condition, determining that the slide operation is the interface jump trigger operation, or when the comparison result indicates that the slide duration does not meet a duration condition, determining that the slide operation is the virtual item viewing operation; obtaining the slide distance of the slide operation, comparing the slide distance with the set slide distance to obtain a comparison result, and when the comparison result indicates that the slide distance meets a distance condition, determining that the slide operation is the interface jump trigger operation, or when the comparison result indicates that the slide distance does not meet a distance condition, determining that the slide operation is the virtual item viewing operation; obtaining a pressure parameter of the slide operation, comparing the pressure parameter with the set pressure parameter to obtain a comparison result, and when the comparison result indicates that the pressure parameter meets a pressure condition, determining that the slide operation is the interface jump trigger operation, or when the comparison result indicates that the pressure parameter does not meet a pressure condition, determining that the slide operation is the virtual item viewing operation; or obtaining a number of contacts of the slide operation, comparing the number of contacts with the set number of contacts to obtain a comparison result, and when the comparison result indicates that the number of contacts is equal to the set number of contacts, determining that the slide operation is the interface jump trigger operation, or when the comparison result indicates that the number of contacts is different from the set number of contacts, determining that the slide operation is the virtual item viewing operation.

In some embodiments, the first processing interface and the second processing interface are photographed by a virtual camera, and each component of the virtual item is configured with a lens parameter corresponding to the virtual camera. The obtaining module 5553 is further configured to: before the switching module 5552 switches from displaying the first processing interface to displaying the second processing interface, obtain a second lens parameter configured for the second component. The virtual item processing apparatus 555 further includes an adjustment module 5559, a photographing module 55510, and a loading module 55511. The adjustment module 5559 is configured to adjust a posture of the virtual camera in the virtual scene based on the second lens parameter. The photographing module 55510 is configured to call the adjusted virtual camera to photograph the virtual item. The loading module 55511 is configured to load the processing control of the second component in a picture obtained through the photographing, to obtain the second processing interface.

In some embodiments, the lens parameter includes at least one of the following parameters: a component corresponding to a lens, a rotation angle of the lens, an offset of the lens relative to a start point of the component, a distance between the lens and a focal point, or a viewing angle of the lens.

In some embodiments, the obtaining module 5553 is further configured to obtain a first lens parameter configured for the first component. The virtual item processing apparatus 555 further includes an interpolation module 55512 and an insertion module 55513. The interpolation module 55512 is configured to perform interpolation between the first lens parameter and the second lens parameter, to obtain at least one intermediate lens parameter, each intermediate lens parameter being configured for: adjusting the posture of the virtual camera, and calling the adjusted virtual camera to photograph the virtual item, to obtain a corresponding intermediate interface. The insertion module 55513 is configured to insert at least one intermediate interface when the switching module 5552 switches from displaying the first processing interface to displaying the second processing interface.

The interpolation module 55512 is further configured to: multiply the second lens parameter with t, to obtain a first multiplication result, t being time elapsed after the switching starts, and a value range of t satisfying: 0≤t≤T, T being total time of switching from the first processing interface to the second processing interface, and T being a real number greater than 0; multiply a result of subtracting t from T with the first lens parameter, to obtain a second multiplication result; and determine a sum of the first multiplication result and the second multiplication result as the at least one intermediate lens parameter.

In some embodiments, the display module 5551 is further configured to: before displaying the first processing interface, display a virtual item viewing interface, the virtual item viewing interface including a plurality of components of the virtual item. The transferring module 5558 is further configured to: in response to a selection operation for the first component in the virtual item viewing interface, transfer to displaying the first processing interface.

In some embodiments, the switching module 5552 is further configured to: in response to a third component of the virtual item satisfying a processing condition, switch from displaying the second processing interface to displaying a third processing interface different from the second processing interface, the third processing interface including the third component and a processing control of the third component.

In some embodiments, the processing condition includes at least one of the following: a loss degree of the third component is greater than or equal to a loss degree threshold; or a new accessory available for use by the third component is obtained.

Descriptions of the apparatus embodiments are similar to the descriptions of the method embodiments. The apparatus embodiments have beneficial effects similar to those of the method embodiments, and therefore, are not repeatedly described. The technical details not exhausted in the virtual item modification processing apparatus according to the embodiments of this application can be understood according to the descriptions of the accompanying drawing of FIG. 3 or FIG. 6.

An embodiment of this application provides a computer program product, including a computer program or computer-executable instructions stored in a computer-readable storage medium. A processor of a computer device reads the computer-executable instructions from the computer-readable storage medium, and the processor executes the computer-executable instructions, to enable the computer device to perform the virtual item modification processing method according to the embodiments of this application.

An embodiment of this application provides a non-transitory computer-readable storage medium having computer-executable instructions stored therein. When the computer-executable instructions are executed by a processor, the processor is caused to perform the virtual item modification processing method according to the embodiments of this application, for example, the virtual item modification processing method shown in FIG. 3 or FIG. 6.

In some embodiments, the computer-readable storage medium may be a memory such as an FRAM, a ROM, a PROM, an EPROM, an EEPROM, a flash memory, a magnetic surface memory, an optical disk, or a CD-ROM; or may be any device including one of or any combination of the foregoing memories.

In some embodiments, the executable instructions can be written in a form of a program, software, a software module, a script, or code and according to a programming language (comprising a compiler or interpreter language or a declarative or procedural language) in any form, and may be deployed in any form, comprising an independent program or a module, a component, a subroutine, or another unit suitable for use in a computing environment.

For example, the executable instructions may be deployed to be executed on one electronic device, or on a plurality of electronic devices located at one location, or on a plurality of electronic devices distributed at a plurality of locations and interconnected through a communication network.

The foregoing descriptions are merely embodiments of this application and are not intended to limit the protection scope of this application. Any modification, equivalent replacement, or improvement made without departing from the spirit and range of this application shall fall within the protection scope of this application.

What is claimed is:

1. A virtual item processing method executed by an electronic device, the method comprising:
displaying a processing entrance for a virtual item in a virtual scene;
displaying a first processing interface in response to a trigger operation for the processing entrance, the first processing interface comprising at least a processing control;
in response to a trigger operation for the processing control, updating the virtual item; and
in response to an interface jump trigger operation, switching from the first processing interface to a second processing interface different from the first processing interface.

2. The method according to claim 1, wherein
the first processing interface further comprises a first component of the virtual item; and
the updating the virtual item comprises:
in response to the trigger operation for the processing control, updating the first component such that components in the updated virtual item other than the first component are, at most, partially displayed.

3. The method according to claim 1, wherein
the first processing interface further comprises a second component of the virtual item, and the interface jump trigger operation is a trigger operation for the second component; and
the switching from the first processing interface to a second processing interface different from the first processing interface comprises:
in response to the trigger operation for the second component in the first processing interface, switching from the first processing interface to the second processing interface different from the first processing interface.

4. The method according to claim 1, wherein
the first processing interface further comprises at least one browsing control respectively corresponding to at least one direction, and the interface jump trigger operation is a trigger operation for the browsing control; and
the switching from the first processing interface to a second processing interface different from the first processing interface comprises:
in response to a trigger operation for a browsing control corresponding to a first direction in the first processing interface, switching from the first processing interface to the second processing interface different from the first processing interface, the first processing interface comprising a second component, a distribution direction of the second component relative to the first component being in an opposite direction of the first direction, and the second component being a component closest to the first component in the opposite direction.

5. The method according to claim 1, wherein
the interface jump trigger operation is a slide operation; and
the switching from the first processing interface to a second processing interface different from the first processing interface comprises:
in response to the slide operation of which a slide direction of the slide operation is located in a first direction range of the first component in the first processing interface, switching from the first processing interface to the second processing interface different from the first processing interface, a second component being distributed in an opposite range of the first direction range, and a distance between the second component and the first component being proportional to a slide distance of the slide operation.

6. The method according to claim 1, wherein
the interface jump trigger operation is a slide operation; and
the switching from the first processing interface to a second processing interface different from the first processing interface comprises:
in response to the slide operation of which a slide direction of the slide operation is located in a first direction range of the first component in the first processing interface, switching from the first processing interface to the second processing interface different from the first processing interface, a second component being distributed in a opposite range of the first direction range, and the second component being a component closest to the first component in the opposite range.

7. The method according to claim 1, wherein
the first processing interface and the second processing interface are photographed by a virtual camera, and each component of the virtual item is configured with a lens parameter corresponding to the virtual camera; and
before the switching from the first processing interface to the second processing interface different from the first processing interface, the method further comprises:
obtaining a second lens parameter configured for the second component;
adjusting a posture of the virtual camera in the virtual scene based on the second lens parameter, and calling the adjusted virtual camera to photograph the virtual item; and
loading the processing control of the second component in a picture obtained through the photographing, to obtain the second processing interface.

8. The method according to claim 1, wherein before displaying the first processing interface, the method further comprises:
displaying a virtual item viewing interface, the virtual item viewing interface comprising a plurality of components of the virtual item; and
in response to a selection operation for the first component in the virtual item viewing interface, displaying the first processing interface.

9. The method according to claim 1, further comprising:
in response to a third component of the virtual item satisfying a processing condition, switching from the second processing interface to a third processing interface different from the second processing interface, the third processing interface comprising the third component and a processing control of the third component.

10. An electronic device, comprising:
a memory, configured to store executable instructions; and
a processor, configured to: when executing the executable instructions stored in the memory, cause the electronic device to implement a virtual item processing method including:
displaying a processing entrance for a virtual item in a virtual scene;
displaying a first processing interface in response to a trigger operation for the processing entrance, the first processing interface comprising at least a processing control;
in response to a trigger operation for the processing control, updating the virtual item; and
in response to an interface jump trigger operation, switching from the first processing interface to a second processing interface different from the first processing interface.

11. The electronic device according to claim 10, wherein
the first processing interface further comprises a first component of the virtual item; and
the updating the virtual item comprises:
in response to the trigger operation for the processing control, updating the first component such that components in the updated virtual item other than the first component are, at most, partially displayed.

12. The electronic device according to claim 10, wherein
the first processing interface further comprises a second component of the virtual item, and the interface jump trigger operation is a trigger operation for the second component; and
the switching from the first processing interface to a second processing interface different from the first processing interface comprises:
in response to the trigger operation for the second component in the first processing interface, switching from the first processing interface to the second processing interface different from the first processing interface.

13. The electronic device according to claim 10, wherein
the first processing interface further comprises at least one browsing control respectively corresponding to at least one direction, and the interface jump trigger operation is a trigger operation for the browsing control; and
the switching from the first processing interface to a second processing interface different from the first processing interface comprises:
in response to a trigger operation for a browsing control corresponding to a first direction in the first processing interface, switching from the first processing interface to the second processing interface different from the first processing interface, the first processing interface comprising a second component, a distribution direction of the second component relative to the first component being in an opposite direction of the first direction, and the second component being a component closest to the first component in the opposite direction.

14. The electronic device according to claim 10, wherein
the interface jump trigger operation is a slide operation; and
the switching from the first processing interface to a second processing interface different from the first processing interface comprises:
in response to the slide operation of which a slide direction of the slide operation is located in a first direction range of the first component in the first processing interface, switching from the first processing interface to the second processing interface different from the first processing interface, a second component being distributed in an opposite range of the first direction range, and a distance between the second component and the first component being proportional to a slide distance of the slide operation.

15. The electronic device according to claim 10, wherein
the interface jump trigger operation is a slide operation; and
the switching from the first processing interface to a second processing interface different from the first processing interface comprises:
in response to the slide operation of which a slide direction of the slide operation is located in a first direction range of the first component in the first processing interface, switching from the first processing interface to the second processing interface different from the first processing interface, a second component being distributed in a opposite range of the first direction range, and the second component being a component closest to the first component in the opposite range.

16. The electronic device according to claim 10, wherein
the first processing interface and the second processing interface are photographed by a virtual camera, and each component of the virtual item is configured with a lens parameter corresponding to the virtual camera; and
before the switching from the first processing interface to the second processing interface different from the first processing interface, the method further comprises:
obtaining a second lens parameter configured for the second component;
adjusting a posture of the virtual camera in the virtual scene based on the second lens parameter, and calling the adjusted virtual camera to photograph the virtual item; and
loading the processing control of the second component in a picture obtained through the photographing, to obtain the second processing interface.

17. The electronic device according to claim 10, wherein before displaying the first processing interface, the method further comprises:
displaying a virtual item viewing interface, the virtual item viewing interface comprising a plurality of components of the virtual item; and
in response to a selection operation for the first component in the virtual item viewing interface, displaying the first processing interface.

18. The electronic device according to claim 10, wherein the method further comprises:
in response to a third component of the virtual item satisfying a processing condition, switching from the second processing interface to a third processing interface different from the second processing interface, the third processing interface comprising the third component and a processing control of the third component.

19. A non-transitory computer-readable storage medium, having computer-executable instructions stored therein, and the computer-executable instructions, when being executed by a processor of an electronic device, causing the electronic device to perform a virtual item processing method including:
displaying a processing entrance for a virtual item in a virtual scene;
displaying a first processing interface in response to a trigger operation for the processing entrance, the first processing interface comprising at least a processing control;
in response to a trigger operation for the processing control, updating the virtual item; and
in response to an interface jump trigger operation, switching from the first processing interface to a second processing interface different from the first processing interface.

20. The non-transitory computer-readable storage medium according to claim 19, wherein the method further comprises:
in response to a third component of the virtual item satisfying a processing condition, switching from the second processing interface to a third processing interface different from the second processing interface, the third processing interface comprising the third component and a processing control of the third component.
